(19) United States
(12) Patent Application Publication
(10) Pub. No.: US 2021/0004095 A1
(43) Pub. Date: Jan. 7, 2021

(54) TOUCHSCREEN PANEL MODULE

(71) Applicant: SHARP KABUSHIKI KAISHA, Sakai City (JP)

(72) Inventors: RYO MATSUDA, Sakai City (JP); KOHJI YABUTA, Sakai City (JP)

(21) Appl. No.: 16/915,227

(22) Filed: Jun. 29, 2020

Related U.S. Application Data
(60) Provisional application No. 62/870,571, filed on Jul. 3, 2019.

(51) Int. Cl. G06F 3/041; B32B 7/12; B32B 7/06; B32B 27/36; B32B 27/30; B32B 27/08

(52) U.S. Cl. CPC G06F 3/041; B32B 7/12; B32B 7/06; B32B 27/36; B32B 27/304; B32B 27/08; G06F 1/1637; G06F 2203/04103; B32B 2307/584; B32B 2457/208; B32B 2250/05; B32B 2250/24; B32B 27/308

(57) ABSTRACT

A touchscreen panel module includes: a separation film removable, a first adhesive layer, a touch-sensor unit shaped in a form of a film and detecting an input position, and a protective film for protecting the touch-sensor unit stacked on top of another in stated order; and an exposure portion partially exposing a surface of the touch-sensor unit from the separation film and the first adhesive layer.

### TECHNICAL FIELD

The present invention relates to a touchscreen panel module.

### RELATED ART

More and more electronic devices such as tablet laptop computers and portable digital assistants are equipped with touchscreen panels to enhance their operability and usability. A recently proposed touchscreen panel member is of a film type. This touchscreen panel member is formed as follows: a transparent electrode layer is formed on either face, or both faces, of a transparent film base material, and an adhesive layer is stacked on each of the transparent electrode layers. To one face of the touchscreen panel member, a display panel is attached. To the other face of the touchscreen panel, a cover film is attached. Before the display panel and the cover film are attached, the touchscreen panel member includes a separation film to cover and protect each of the adhesive layers. (See Japanese Unexamined Patent Application Publication No. 2012-138016).

Described below, for example, are steps to produce a display device including a display panel and this touchscreen panel attached to the display panel. First, a separation film is removed from one of the adhesive layers on the touchscreen panel member, and the cover film is attached to the adhesive layer. Next, the touchscreen panel member with the cover film attached thereto is held and sucked onto a suction stage. A separation film is removed from the other adhesive layer. The touchscreen panel member is attached to the display panel.

Here, on the surface of the cover film, a protective film can be provided to temporally protect the cover film. In such a case, the touchscreen panel member with the cover film attached thereto has the face, provided with the protective film, sucked onto the suction stage. Typically, the adhesiveness of the separation film to the adhesive layer is greater than that of the protective film to the cover film. Hence, when the separation film is removed from the adhesive layer, layers between the cover film and the adhesive layer are also removed together with the separation film and come off the protective film. Hence, a bubble might inevitably be formed between the protective film and cover film. The bubble reduces the adhesiveness of the protective film to the cover film. When the touchscreen panel member is attached to the display panel, the reduced adhesiveness is a concern of defective attachment, such as displacement of the protective film in relation to the cover film. Furthermore, if the removal of the separation film is disrupted before the separation film is completely removed, a streak appears on a portion of the adhesive layer where the removal is disrupted. If layers between the cover film and the adhesive layer are also removed together with the separation film and come off the protective film when the separation film is removed, the removal is highly likely to be disrupted temporarily. The disrupted removal tends to leave the above streak on the adhesive layer.

### SUMMARY OF INVENTION

The present invention is completed in view of the above problems, and intends to reduce defective attachment of a touchscreen panel to a display panel.

(1) An embodiment of the present invention is directed to a touchscreen panel module including: a separation film removable, a first adhesive layer, a touch-sensor unit shaped in a form of a film and detecting an input position, and a protective film for protecting the touch-sensor unit stacked on top of another in stated order; and an exposure portion partially exposing a surface of the touch-sensor unit from the separation film and the first adhesive layer.

(2) Another embodiment of the present invention is directed to the touchscreen panel module according to the feature (1), wherein the separation film and the first adhesive layer each include a notch on a portion of an outer edge of the separation film and the first adhesive layer, and, except for having the notch, the separation film and the first adhesive layer are equal in outline to the touch-sensor unit.

(3) Still another embodiment of the present invention is directed to the touchscreen panel module according to the feature (2), wherein the separation film, the first adhesive layer, and the touch-sensor unit include: a side; an other side angled with the side; and a corner between the side and the other side, and the notch is provided to the corner.

(4) Still another embodiment of the present invention is directed to a touchscreen panel module according to any one of the features (1) to (3), wherein the touch-sensor unit includes: a touch-sensor film for detecting an input position; a cover film for protecting the touch-sensor film; and a second adhesive layer provided between, and bonding together, the touch-sensor film and the cover film, and the protective film is provided on the cover film.

### Advantageous Effects of Invention

The present invention makes it possible to reduce defective attachment of a touchscreen panel to a display panel.

### BRIEF DESCRIPTION OF DRAWINGS

FIG. 1 is a cross-section of a display device according to an embodiment.

FIG. 2 is a cross-section illustrating a touchscreen panel module held by a module support stage according to the embodiment.

FIG. 3 is a plan view of the touchscreen panel module according to the embodiment.

FIG. 4 is a cross-section illustrating a separation film in the process of removal according to the embodiment.

FIG. 5 is a cross-section illustrating how a touchscreen panel is attached to the display panel according to the embodiment.

FIG. 6 is a cross-section illustrating how a first adhesive layer and a touch-sensor unit inevitably come off a protective film when the separation film is removed.

### DESCRIPTION OF EMBODIMENT

### Embodiment

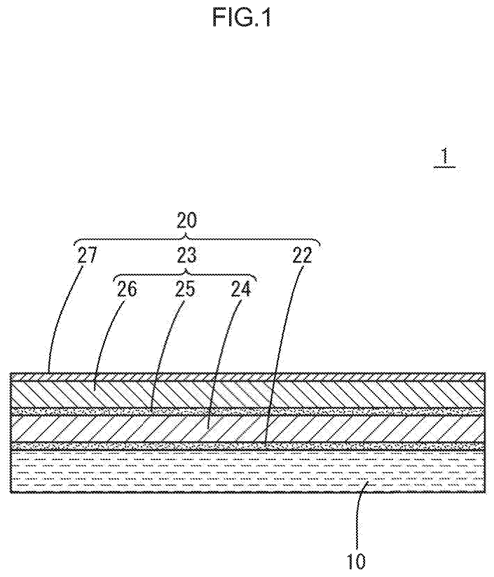

An embodiment of the present invention is described with reference to FIGS. 1 to 6. As illustrated in FIG. 1, the display device 1 according to this embodiment includes: a display panel 10; and a touchscreen panel 20 provided to a display surface of this display panel 10. The display device 1 is included in various kinds of electronic devices such as laptop computers and portable digital assistants. Examples of the display panel 10 include a liquid crystal panel, an organic electroluminescence (EL) panel, and a plasma display panel.

The touchscreen panel 20 is used by a user of the display device 1 for input of position information through contact with his or her finger or a styles, in accordance with an image displayed on the display panel 10. As illustrated in FIG. 1, this touchscreen panel 20 is a member in the form of a film including a first adhesive layer 22, a touch-sensor unit 23, and a protective film 27 stacked on top of another in stated order.

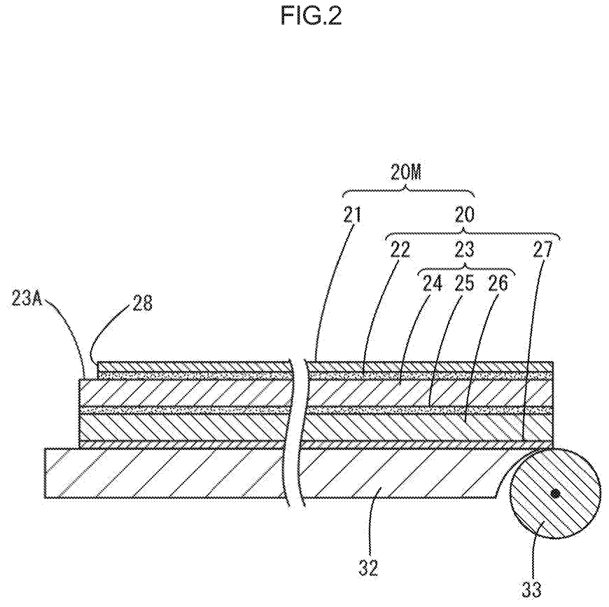

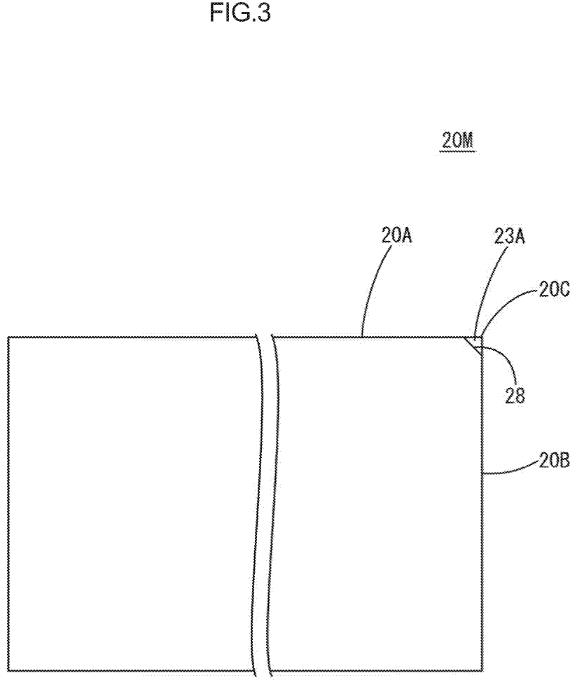

Before the touchscreen panel 20 is attached to the display panel 10, as illustrated in FIG. 2, the first adhesive layer 22 of the touchscreen panel 20 has a surface provided with a separation film 21. Hereinafter, the touchscreen panel 20 including the first adhesive layer 22 whose surface is provided with the separation film 21 is referred to as a “touchscreen panel module 20M.” The touchscreen panel module 20M is shaped into a rectangular sheet, and, as illustrated in FIG. 3, includes: a side 20A; an other side 20B angled with the side 20A; and a corner 20C between the side 20A and the other side 20B.

The separation film 21 is a removable sheet made of, for example, a synthetic resin such as polyethylene terephthalate.

The first adhesive layer 22 bonds the display panel 10 and the touch-sensor unit 23 together, and includes, for example, an optical clear adhesive (OCA) film.

As illustrated in FIGS. 1 and 2, the touch-sensor unit 23 includes: a touch-sensor film 24 for detecting an input position; a cover film 26 for protecting the touch-sensor film 24; and a second adhesive layer 25 provided between, and bonding together, the touch-sensor film 24 and the cover film 26. The touch-sensor unit 23 is overall shaped in the form of a film. The first adhesive layer 22 is provided to a surface of the touch-sensor film 24. The protective film 27 is provided to a surface of the cover film 26.

The touch-sensor film 24 is a sensor in the form of a film, and used for detecting position information input through contact with a finger and a stylus on the touchscreen panel 20. This touchscreen sensor film 24 is configured in a known manner, and includes, for example: a transparent film base material; and a transparent electrode film or a metal mesh patterned to have a predetermined pattern and provided on either side of, or both sides of, the transparent film base material. The film base material is made of, for example, a synthetic resin such as polyethylene terephthalate. The transparent electrode film is formed of a transparent electrode material with high translucency and conductivity such as indium tin oxide (ITO), or zinc oxide (ZnO). The metal mesh is meshed wiring formed of, for example, copper oxide and silver oxide.

The cover film 26 protects the touch-sensor film 24, and is made of, for example, a synthetic resin such as an acrylic resin.

The second adhesive layer 25 bonds the touch-sensor film 24 and the cover film 26 together. Similar to the first adhesive layer 22, the second adhesive layer 25 includes, for example, an OCA film.

The protective film 27 is provided to keep a surface of the cover film 26 from a scratch and a contaminant when the display device 1 is shipped. The protective film 27 is a low-adhesive film including, for example: a base film made of a synthetic resin such as polyvinyl chloride; and an adhesive layer having relatively low adhesiveness and provided on a face of the base film. The protective film 27 is aimed at temporally protecting the cover film 26. When the display device 1 is used after its shipment, the protective film 27 may be removed from the cover film 26 with no disadvantage. Hence, the protective film 27 is removed from the cover film 26 with relatively small force.

As illustrated in FIG. 3, the separation film 21 and the first adhesive layer 22 each include a notch 28 on a portion of an outer edge of the separation film 21 and the first adhesive layer 22. The notch 28 is provided to the corner 20C. Except for having the notch 28, the separation film 21 and the first adhesive layer 22 are equal in outline to the touch-sensor unit 23. A surface of the touch-sensor film 24 included in the touchscreen sensor unit 23 has an area provided with the notch 28. The area includes an exposure portion 23A partially exposing the surface from the separation film 21 and the first adhesive layer 22. The overall surface except the area provided with the notch 28 is covered with the separation film 21 and the first adhesive layer 22.

The above touchscreen panel module 20M is produced, for example, in the steps below.

First, a transparent electrode film or a metal mesh patterned to have a predetermined pattern is formed on both sides of a film base material to obtain the touch-sensor film 24. Prepared next is an adhesive film including a removable sheet and an adhesive layer formed on the removable sheet. This adhesive film is attached to a face of the touch-sensor film 24. In the adhesive film, the removable sheet is the separation sheet 21, and the adhesive layer is the first adhesive layer 22. In a similar manner, another adhesive film is also attached to the other face of the touch-sensor film 24. In the adhesive film, the adhesive layer is the second adhesive layer 25.

Prepared next is the cover film 26 a face of which is provided with the protective film 27. The removable sheet on the second adhesive layer 25 is removed, and the other face of the cover film 26 is attached onto the second adhesive layer 25. This is how the production of the touchscreen module 20M is completed.

Here, as described above, the removable sheet on the second adhesive layer 25 is removed before the separation film 21 on the first adhesive layer 22 is removed. Hence, the removable sheet on the second adhesive layer 25 is designed to be removal from the second adhesive layer 25 with relatively small force; whereas, the separation film 21 on the first adhesive layer 22 is designed to be removal from the first adhesive layer 22 with relatively large force.

The display device 1 with the above touchscreen panel module 20M is produced, for example, in the steps below.

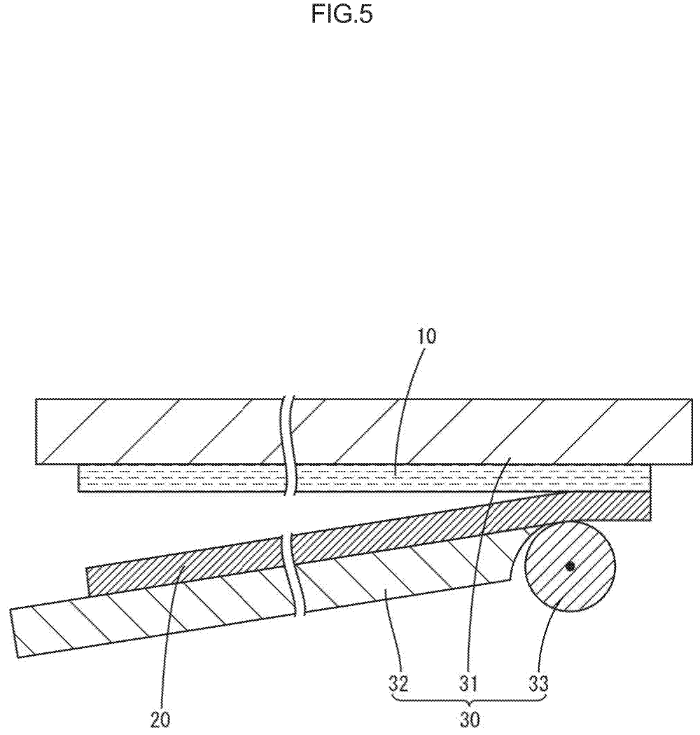

As illustrated in FIGS. 2, 4, and 5, an attachment apparatus 30 to be used for producing the display device 1 includes: a panel support stage 31 supporting the display panel 10; a module support stage 32 supporting the touchscreen panel module 20M; a pressure roller 33 rotatable to press the touch panel 20 against the display panel 10; and a motion mechanism capable of moving the module support stage 32 and the pressure roller 33 in relation to the panel support stage 31. The panel support stage 31 and the module support stage 32 each include a vacuum suction mechanism to suck the display panel 10 and the touchscreen panel module 20M by vacuum suction. Note that FIG. 5 omits the layers included in the touchscreen panel 20.

First, as illustrated in FIG. 2, the touchscreen panel module 20M is sucked onto the module support stage 32 by vacuum suction. Here, the touchscreen panel module 20M is supported so that its face, provided with the protective film 27, makes contact with the module support stage 32.

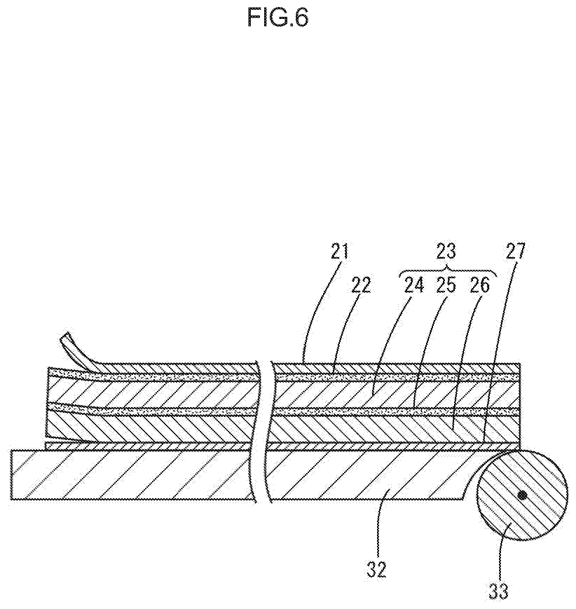

Next, the separation film 21 is removed from the touchscreen panel 20. As described before, the separation film 21 is designed to be removal from the first adhesive layer 22 with relatively large force; whereas, the protective film 27 is designed to be removal from the cover film 26 with relatively small force. Thus, when the separation film 21 is to be removed, layers between the cover film 26 and the first adhesive layer 22 are also removed together with the separation film 21 and come off the protective film 27. Hence, a bubble might inevitably be formed between the protective film 27 and the cover film 26. (See FIG. 6.)

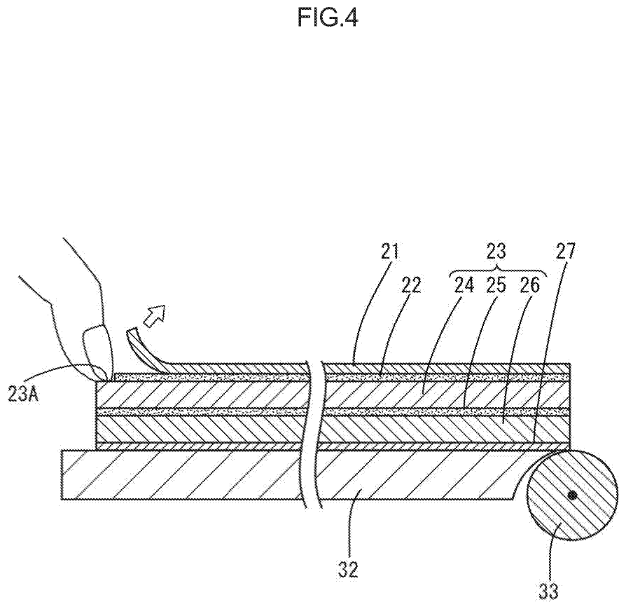

In this embodiment, however, the separation film 21 and the first adhesive layer 22 include the notch 28 on a portion of their edges. The surface of the touch-sensor film 24 has an area provided with the notch 28. The area includes the exposure portion 23A partially exposing the surface from the separation film 21 and the first adhesive layer 22. As illustrated in FIG. 4, the separation film 21 can be removed with the exposure portion 23A pressed against the module support stage 32. Such a feature makes it possible to prevent the layers between the first adhesive layer 22 and the protective film 27 from coming off the cover film 26, and a bubble from forming between the protective film 27 and the cover film 26.

When the separation film 21 is completely removed, the touchscreen panel 20 including the first adhesive layer 22, the touch-sensor film 24, the second adhesive layer 25, the cover film 26, and the protective film 27 is supported on the module support stage 32.

Next, as illustrated in FIG. 5, the display panel 10 is sucked by vacuum suction onto the panel support stage 31. The module support stage 32 and the panel support stage 31 are arranged, so that the display panel 10 and the touchscreen panel 20 are positioned to face each other. Then, the module support stage 32 is angled, so that an end of the touchscreen panel 20 makes contact with the display panel 10, and the pressure roller 33 makes contact with the end of the touchscreen panel 20. Here, the pressure roller 33 makes contact with the face, of the touchscreen panel 20, provided with the protective film 27. After that, the module support stage 32 is transferred in relation to the panel support stage 31, and the pressure roller 33 is rotated to move. The pressure roller 33 rotates to move while pressing the touchscreen panel 20, so that the touchscreen panel 20 is sequentially attached to the display panel 10 across one end to the other. Hence, the attachment of the touchscreen panel 20 to the display panel 10 is completed, and the display device 1 is finalized.

As can be seen, in the step of removing the separation film 21, prevented are formation of a bubble between the protective film 27 and the cover film 26, and the resulting reduction in adhesiveness of the protective film 27 to the cover film 26. When the touchscreen panel 20 is attached to the display panel 10, such a feature makes it possible to prevent defective attachment due to displacement of the protective film 27 in relation to the cover film 26, and a wrinkle on the protective film 27 caused when the pressure roller 33 rotates to move while pressing the touchscreen panel 20.

As can be seen in this embodiment, the touchscreen panel module 20M includes: the separation film 21 removable, the first adhesive layer 22, the touch-sensor unit 23 shaped in the form of a film and detecting an input position, and the protective film 27 for protecting the touch-sensor unit 23 stacked on top of another in stated order; and the exposure portion 23A partially exposing a surface of the touch-sensor unit 23 from the separation film 21 and the first adhesive layer 22.

Such a feature allows the separation film 21 to be removed with the exposure portion 23A pressed, making it possible to prevent the first adhesive layer 22 and the touch-sensor unit 23 from being removed together with the separation film 21 and coming off the cover film 27, and a bubble from forming between the protective film 27 and the cover film 26. The feature makes it possible to reduce defective attachment of the touchscreen panel 20 to the display panel 10.

Moreover, the separation film 21 and the first adhesive layer 22 each include the notch 28 on a portion of an outer edge of the separation film 21 and the first adhesive layer 22. Except for having the notch 28, the separation film 21 and the first adhesive layer 22 are equal in outline to the touch-sensor unit 23.

Thanks to this feature, the surface of the touch-sensor film 24 included in the touchscreen sensor unit 23 has an area provided with the notch 28. The area includes the exposure portion 23A partially exposing the surface from the separation film 21 and the first adhesive layer 22. The overall surface except the area provided with the notch 28 is covered with the separation film 21 and the first adhesive layer 22. Hence, the exposure portion 23A is provided in a minimum necessity area on the surface of the touch-sensor film 24, and the first adhesive layer 22 covers the other area of the surface of the touch-sensor film 24. Such a feature makes it possible to reliably attach the touchscreen panel 20 to the display panel 10.

Furthermore, the separation film 21, the first adhesive layer 22, and the touch-sensor unit 23 include: the side 20A, the other side 20B angled with the side 20A, and the corner 20C between the side 20A and the other side 20B. The notch 28 is provided to the corner 20C.

Thanks to this feature, the notch 28 and the exposure portion 23A are provided to the corner 20C, making it possible to facilitate removal of the separation film 21 with the exposure portion 23A pressed.

### Other Embodiments

The present invention shall not be limited to the embodiment described above and presented in the drawings. For example, embodiments below are also included in the technical scope of the present invention.

(1) For example, the separation film and the first adhesive layer may be slightly smaller in outline than the touch-sensor film, and the edge on the surface of the touch-sensor film may act as the exposure portion exposing from the first adhesive layer.

(2) The notch may be disposed in any place other than the corner of the touchscreen panel module. For example, the notch may be a recess formed on a side of the separation film and the first adhesive layer.

(3) The notch may be provided to two or more places.

(4) The touch-sensor film may be, for example, a single-sided touch panel including two film materials attached together. Each of the film materials may be made of, for example, a base material film a face of which is provided with a transparent electrode layer.

(5) The configuration of the touch-sensor unit shall not be limited to any particular one. The touch-sensor unit may include, for example, an optical film such as a polarizing film and a phase difference film.

1. A touchscreen panel module comprising:
a separation film removable, a first adhesive layer, a touch-sensor unit shaped in a form of a film and detecting an input position, and a protective film for protecting the touch-sensor unit stacked on top of another in stated order; and
an exposure portion partially exposing a surface of the touch-sensor unit from the separation film and the first adhesive layer.

2. The touchscreen panel module according to claim 1, wherein
the separation film and the first adhesive layer each include a notch on a portion of an outer edge of the separation film and the first adhesive layer, and, except for having the notch, the separation film and the first adhesive layer are equal in outline to the touch-sensor unit.

3. The touchscreen panel module according to claim 2, wherein
the separation film, the first adhesive layer, and the touch-sensor unit include: a side; an other side angled with the side; and a corner between the side and the other side, and the notch is provided to the corner.

4. The touchscreen panel module according to claim 1, wherein
the touch-sensor unit includes: a touch-sensor film for detecting an input position; a cover film for protecting the touch-sensor film; and a second adhesive layer provided between, and bonding together, the touch-sensor film and the cover film, and
the protective film is provided on the cover film.
